(19) United States
(12) Patent Application Publication
(10) Pub. No.: US 2011/0285716 A1
(43) Pub. Date: Nov. 24, 2011

(54) Evaluation of Radiation Dose Tolerance Limits

(76) Inventor: Jimm Grimm, Huntingdon Valley, PA (US)

(21) Appl. No.: 12/983,463

(22) Filed: Jan. 3, 2011

Related U.S. Application Data
(60) Provisional application No. 61/335,371, filed on Jan. 6, 2010.
(60) Provisional application No. 61/335,351, filed on Jan. 6, 2010.

(51) Int. Cl. G06T 11/20

(52) U.S. Cl. 345/440

(57) ABSTRACT

A software device that aids the user to evaluate the dose distribution and dose tolerance limits for radiation therapy treatment plans. Radiation therapy treats a desired tumor volume as well as undesired volumes of critical anatomical structures within the patient. The dose volume histogram (DVH) is commonly used to assess the volume of tumor and the volumes of critical structures receiving certain doses. The disclosed invention overlays historical dose statistical information on the dose volume histogram to conveniently enable the user to evaluate the quality of the radiation treatment plan.

### CROSS-REFERENCE TO RELATED APPLICATIONS

This application claims the benefit of provisional patent application Ser. No. 61/335,371, filed Jan. 6, 2010 by Jimm Grimm

This application is related to provisional patent application Ser. No. 61/335,351, filed Jan. 6, 2010 by Jimm Grimm.

### REFERENCES CITED

References Cited

| | | |
|---|---|---|
| 3,871,579 | Mar. 18, 1975 | Inamura |
| 3,987,281 | Oct. 19, 1976 | Hodes |
| 4,845,370 | Jul. 4, 1989 | Thompson, et al. |
| 5,012,357 | Apr. 30, 1991 | Schoeppel, et al. |
| 5,205,289 | Apr. 27, 1993 | Hardy, et al. |
| 5,339,812 | Aug. 23, 1994 | Hardy, et al. |
| 5,647,663 | Jul. 15, 1997 | Holmes |
| 6,167,294 | Dec. 26, 2000 | Busch |
| 6,222,544 | Apr. 24, 2001 | Tarr, et al. |
| 6,393,096 | May 21, 2002 | Carol, et al. |
| 6,741,674 | May 25, 2004 | Lee |
| 7,027,557 | Apr. 11, 2006 | Llacer |
| 7,186,991 | Mar. 6, 2007 | Kato, et al. |
| 7,362,848 | Apr. 22, 2008 | Saracen, et al. |
| 7,593,505 | Sep. 22, 2009 | Saracen, et al. |

Shipley W U, Tepper J E, Prout G R, Verhey L J, Mendiondo O A, Goitein M, Koehler A M, Suit H D. Proton radiation as boost therapy for localized prostatic carcinoma. J. Am. Med. Assoc. 1979 May; 241(18):1912-5.
Austin-Seymour M M, Chen G T, Castro J R, Saunders W M, Pitluck S, Woodruff K H, Kessler M. Dose volume histogram analysis of liver radiation tolerance. Int J Radiat Oncol Biol Phys. 1986 January; 12(1):31-5.
Mohan R, Brewster L J, Barest G D. A technique for computing dose volume histograms for structure

### FEDERALLY SPONSORED RESEARCH

N/A

### SEQUENCE LISTING OR PROGRAM

Program flowchart in FIG. 7.

### FIELD OF THE INVENTION

The invention relates to the field of radiation therapy treatment planning.

### BACKGROUND AND SUMMARY OF THE INVENTION

For most treatment modalities in radiation oncology, a 3D image of the patient's internal anatomy is usually obtained using CT scan, MR scan, ultrasound, PET scan or other imaging techniques. A physician, physicist, or dosimetrist then contours (i.e. draws) outlines of patient anatomy in a treatment planning system. All relevant anatomical structures are contoured; including tumor targets as well as critical organs. The treatment planning system is then used to determine the expected radiation dose distribution throughout the 3D image representation of the patient. From this overall 3D dose distribution, the treatment planning system computes the dose to all the contoured anatomical structures. In the prior art, the dose to all contoured anatomical structures is summarized in the form of a Dose Volume Histogram (DVH), which is a plot of volume versus dose, or alternatively, a plot of dose versus volume. The embodiment disclosed in this description is of the first form, but it also applies to the dose versus volume form, just by exchanging the x and y axes.

One slice of a CT scan is shown in FIG. 1 with dose lines overlaid. The entire CT scan consists of numerous such 2D slices, comprising the entire 3D volume of the target area within the patient. The treatment planning system determines how many points in each contoured anatomical structure receive each particular dose value, and it organizes this information into a DVH, as shown in FIG. 2.

As the prior art abundantly shows, dose tolerance limits and computerized treatment planning systems that calculate DVHs have been in existence for more than twenty five years. However, until the presently disclosed invention there is still no treatment planning system that overlays the dose tolerance limits onto the DVH and warns the user if any limits have been exceeded. The conventional radiation dose tolerance limits (Emami et al 1991) relate to a large volume of the contoured anatomical structure, such as ⅓ of the total volume, ⅔ of the total volume, or the dose to the entire volume. These large volumes can visually be seen on the DVH, so although it would be more convenient and comprehensive to use a system like the present invention, clinical practitioners have become accustomed to doing this manually for the past twenty five years.

The stereotactic body radiation therapy (SBRT) dose tolerance limits (Wulf et al 2001, Chang & Timmerman 2007) are dramatically different, however. Whereas in conventional radiation therapy treatments the goal is to deliver a uniform dose over a fairly large target, the goal of SBRT is to deliver a much higher dose per treatment to a small, focal, precisely defined target (Lax 1993, Lax et al 1994, Murphy & Cox 1996) with much steeper dose gradients. The SBRT dose tolerance limits are typically for a much smaller volume, like five cubic centimeters (5 cc), or 1 cc, or even the maximum point dose. These very small volumes of dose are not as easily visualized on the DVH making the presently disclosed invention much more important for patient safety—yet still this has been performed manually in all clinics that have treated with SBRT for the past fifteen years, probably due to clinical habits from conventional radiation therapy.

An example DVH of volume versus dose is shown in FIG. 2 for an SBRT treatment near a patient's small bowel. The disclosed invention works equally well for any contoured anatomical targets or critical structures; small bowel is just presented as an example to facilitate explanation. The disclosed invention overlays historical dose statistical information onto the DVH, as shown in FIG. 3 for the example in FIG. 2. The quality of the treatment plan in FIG. 2 is very subjective because there is no concise information to indicate whether the plan is good or not. However, it is much more useful to display the plan as in FIG. 3, where it becomes clear that a certain volume of small bowel receives a dose level that historically has been associated with some increased likelihood of complications.

In FIGS. 4 and 5 another example is shown that highlights the importance of this invention for SBRT treatments. In FIG. 5 it may be clearly seen that although some increased chance of complications was historically reported at a dose of 2700 cGy, the esophagus DVH for this example patient goes all the way up to 3800 cGy. In contrast, the prior art FIG. 4 is more hazardous to patients because no dose statistics are explicitly shown. Since the volume of esophagus exceeding the dose statistics level is small, it might not be noticed by manual inspection. Even though the volume is small, it is receiving such a high dose that the patient could be at increased risk of esophageal fistula. This invention has the potential to improve patient safety by clearly warning clinical practitioners whenever the dose to contoured anatomical structures is too high, thereby showing which parts of the treatment plan need to be improved.

### BRIEF DESCRIPTION OF THE DRAWINGS

FIG. 1 is one slice of a treatment plan for a patient with dose lines overlaid on the CT scan.

FIG. 2 is a prior art Dose Volume Histogram.

FIG. 3 is the disclosed invention: prior art Dose Volume Histogram with dose statistics overlaid.

FIG. 4 is another prior art Dose Volume Histogram.

FIG. 5 is the disclosed invention: prior art Dose Volume Histogram with dose statistics overlaid.

FIG. 6 is a flowchart of the disclosed invention.

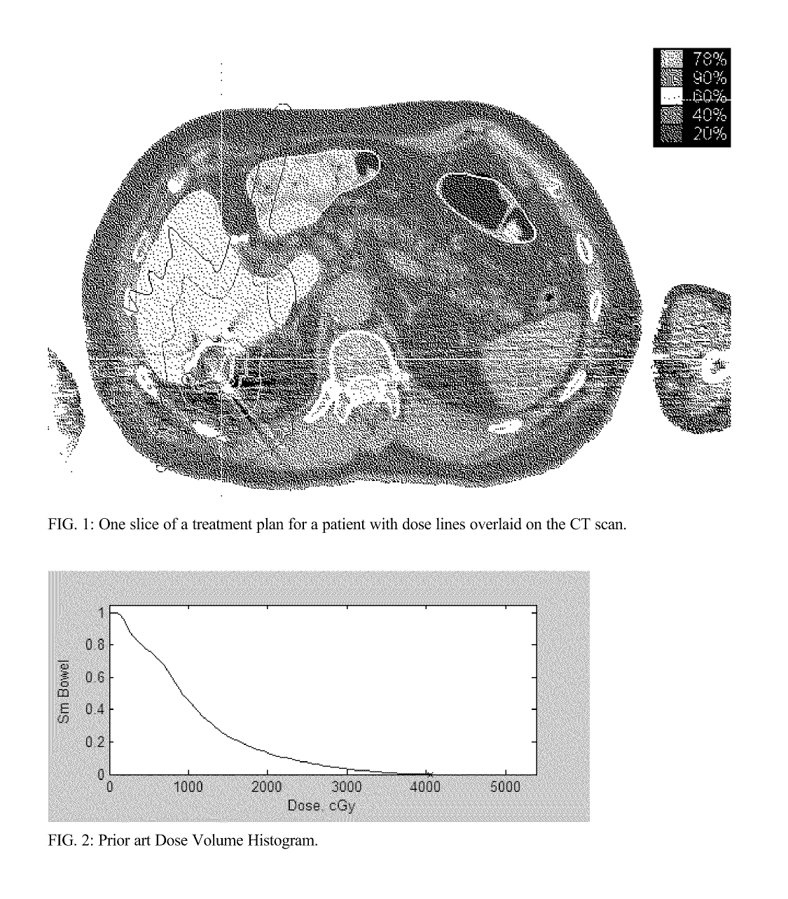

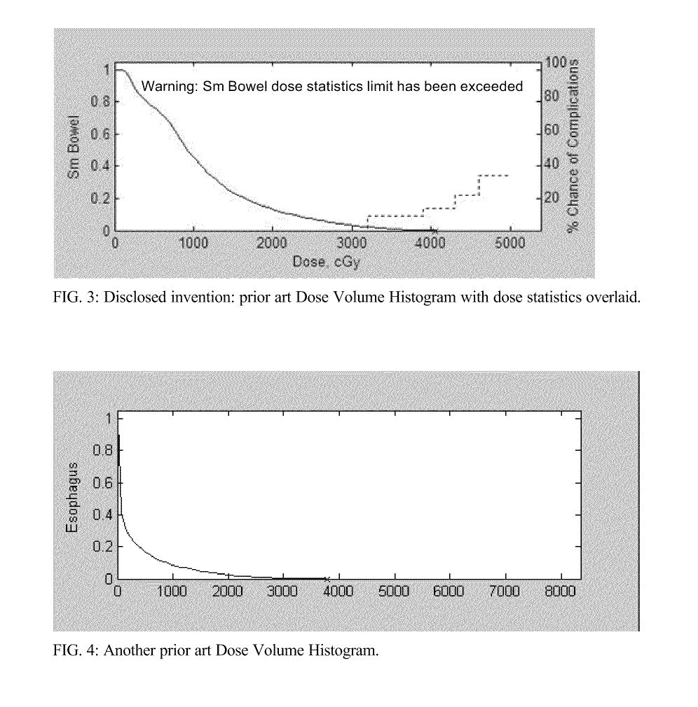

### DETAILED DESCRIPTION OF THE INVENTION

A DVH can be expressed as a plot of \vec{x}, \vec{y}, where \vec{x} is a vector of the range of doses in the plan, from the minimum dose to the maximum dose, and \vec{y} is a vector of the volumes of the anatomical structure receiving each particular dose. The dose \vec{x} and the volume \vec{y} may be expressed in any applicable units, either absolute units or in normalized relative units.

Similarly, dose statistics may be expressed as a plot of \vec{x}, \vec{z}, where \vec{x} is a vector of the range of doses of interest, from the minimum dose to the maximum dose, and \vec{z} is a vector of the estimated probability or percent chance of complications due to that particular dose.

Using this notation, the disclosed invention may be described by the flowchart in FIG. 6. The user can export the DVH data 620 from the treatment planning system into a computer file, or the treatment planning system could call the presently disclosed invention as a function call. In either case, the first import module 610 imports the DVH data 620. The historical dose statistics 640 could be stored in a computer file, or another program could enable the user to specify the historical dose statistics 640 and call the disclosed invention as a function call. In either case, the second import module 630 loads the historical dose statistics 640. Module 650 plots the DVH data 620. Module 660 then overlays the historical dose statistics 640 onto the same plot. Finally, if any dose statistic levels 640 have been exceeded, module 670 warns the user.

The warning to the user could be provided in many ways: a textual message could be displayed, or the DVH or dose tolerance limit could be changed to a certain color, or an asterisk or other marker could be displayed, the background color could change, and audible sound could be used, or various other means could be employed to warn the user.

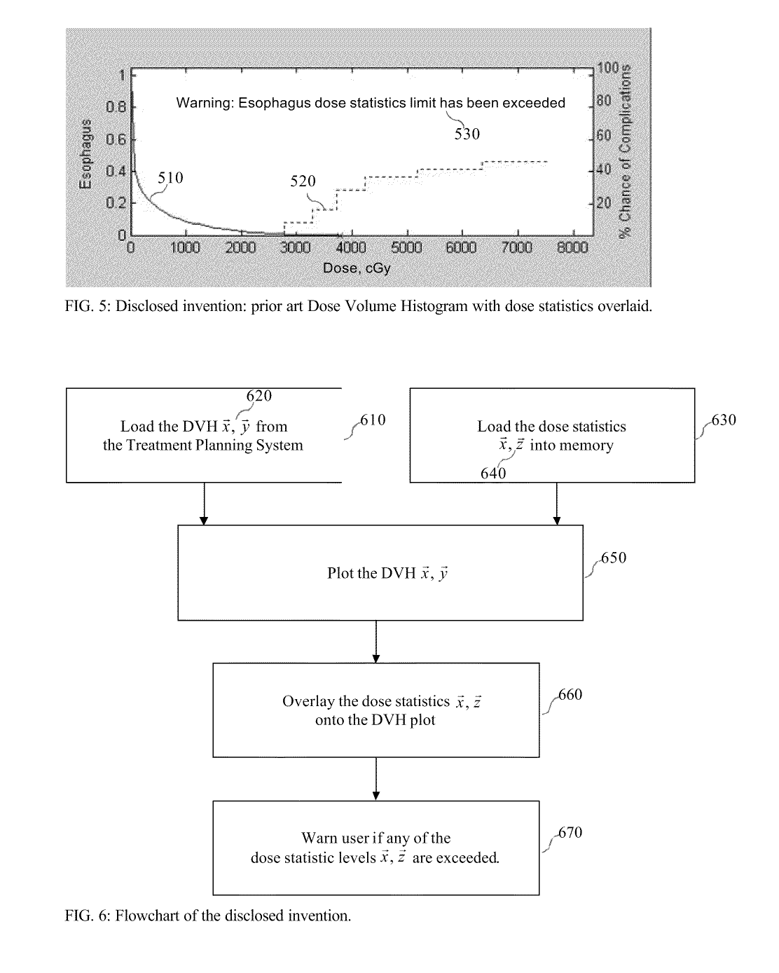

An example is shown in FIG. 5. The plot of the DVH data 620 is curve 510. In this example, the historical dose statistics 640 have been plotted as curve 520. The DVH curve 510 does cross the historical dose statistics curve 520, so this dose statistic level has been exceeded by the DVH data 620. Therefore, the warning message 530 has been displayed to warn the user of the excessive dose.

While the invention has been described in connection with what is presently considered to be the most practical and preferred embodiment, it is to be understood that the invention is not to be Limited to the disclosed embodiment, but on the contrary, is intended to cover various modifications and equivalent arrangements included within the spirit and scope of the appended claims.

What is claimed is:

1. A method in a computer that plots the DVH from a radiation therapy treatment planning system graphically,

2. The method of claim 1, wherein historical dose statistical information for contoured anatomical structures are overlaid onto the DVH plots,

3. The method of claims 1 and 2, wherein the user is warned if the DVH to any of the contoured anatomical structures exceeds any of the user-specified dose statistic levels.
